(19) United States
(12) Patent Application Publication
(10) Pub. No.: US 2004/0226880 A1
(43) Pub. Date: Nov. 18, 2004

(54) Apparatus for collecting and conveying clean liquor from a separating tank and systems utilizing same

(76) Inventors: Robert Kent Brown, Salt Lake City, UT (US); Vaughn J. Weston, Kearns, UT (US)

Correspondence Address: TRASK BRITT, P.O. BOX 2550, SALT LAKE CITY, UT, 84110, US

(21) Appl. No.: 10/440,392

(22) Filed: May 16, 2003

(51) Int. Cl. B01D 12/00

(52) U.S. Cl. 210/519

(57) ABSTRACT

A laundering apparatus for collecting fluid, such as clean liquor, from a tank. The laundering apparatus includes a central conduit which is configured to be located near, and at least partially circumscribe, the radial center of the tank. At least one substantially linear conduits is tangentially coupled to, and in fluid communication with, the central conduit. One or more openings defined within the at least one substantially linear conduits is configured to draw a volume of fluid therethrough into the laundering apparatus. The at least one substantially linear conduit may also be substantially radially extending out through the wall of the tank. An access port may be formed in the radially distal end of the at least one substantially linear conduit to facilitate cleaning of the laundering apparatus from a location outside of the tank.

### BACKGROUND OF THE INVENTION

1 Field of the Invention

The present invention relates generally to the separation of liquid and solid components of a slurry and, more specifically, to an apparatus employed in, for example, a clarifier tank for collection and conveyance of a clean liquor which has been separated from the slurry.

2 State of the Art

A variety of industries use clarifier tanks to separate an influent feed slurry (i.e., a liquid carrying suspended particles) into a supernatant “clarified” liquid phase having a lower concentration of particles than the influent feed slurry, and an underflow stream having a higher concentration of particles than the influent feed slurry, the underflow stream being in the form of a sludge or thickened mud on the bottom of the tank. The sludge may then be collected and disposed of or subjected to further processing. Likewise, the clarified liquor may be collected for further processing or disposal, or may be reused, for example, to assist in similar separation processes.

Conventional clarifiers, and similar sedimentation tanks, include what may be termed a launder which collects the supernatant or clarified liquor and conveys the liquor out of the tank. In some clarifiers, the launder includes a baffle and weir assembly which allows clarified liquor to flow over the weir into a collection zone, which may be an open channel, once the liquid within the tank has risen to a predetermined level. Such a configuration is simple and effective for many applications but also requires that the baffle and weir assembly remain at a fixed elevation which ultimately defines the operating liquid level of the clarifier. In other words, the liquid level within the clarifier must be at the elevation the baffle and weir assembly for collection to take place. Thus, such a baffle and weir arrangement may not be particularly suited for an application wherein the liquid level within the tank varies in any substantial manner during operation thereof. Also, such a baffle and weir arrangement may not be best suited for use in closed tanks where, due to the configuration of the tank, the launder may need to be located such that it may be submerged below a set liquid level.

In some applications, it may be desirable to contemporaneously clarify a slurry and store a volume of clarified slurry within the same tank. For example a unit storage clarifier may be used in the clarification of green liquor in a recausticizing process wherein the unit storage tank includes a volume defined within the tank above the clarification or settling zone for storage of clarified liquor. The added storage capacity provided by a unit storage tank conventionally results in a liquid level which varies, within limits, over time. With the liquid level varying over time, the laundering apparatus used to collect the clarified liquor may be positioned at or below the intended minimum operational liquid level such that the laundering apparatus remains substantially submerged and continues to collect the clarified liquor even if the volume of stored clarified liquor fluctuates as long as the actual liquid level remains above the intended minimum operational liquid level. However, in order to ensure that it clarifies the liquor which is being collected, it is also desirable to keep the laundering apparatus substantially above the floor of the clarifier tank as the liquid closer to the floor tends to exhibit a substantially higher concentration of particulates (which are in the process of settling to the floor of the tank) than that which is at a relatively higher elevation.

A laundering apparatus suitable for use in a unit storage clarifier may include one or more conduits submerged within the clarified liquor having a plurality of openings formed in the conduits to draw a volume of clarified liquor from the tank, through the conduits to another locale for further processing, reuse or appropriate disposal thereof. For example, referring to FIG. 1, a plan view of a clarifier 10 is shown which includes a tank 12 for containing a volume of clarified liquid therein and a laundering apparatus 14 for collecting and conveying a volume of the clarified liquid. The laundering apparatus 14 includes a plurality of radially extending conduits 16, sometimes referred to as bustle pipes or radial launders, which are coupled to an annular or ring-shaped conduit 18, the ring-shaped conduit 18 being disposed about a feedwell 19. The radially extending conduits 16 have a plurality of openings 20 formed therein to draw clarified liquid therethrough. The ring shaped conduit 18 acts as a manifold for the radially extending conduits 16 and may also have a plurality of openings formed therein (not shown) for collection of clarified liquid. One of the radially extending conduits 16 may act as a common effluent discharge conduit 16A such that clarified liquor drawn into any of the plurality of conduits 16 and 18 will eventually be conveyed through the discharge conduit 16A and to a destination remotely located from the clarifier 10.

The continued collection of clarified liquor through the laundering apparatus 14, which liquor may still have a certain level of particulates therein, may result in the gradual build-up of solids along the interior surfaces of the conduits 16 and 18, sometimes referred to as scaling. Such material build-up results in the inefficient flow of clarified liquor through the conduits 16 and 18 and may eventually block flow through one or more of the conduits 16 and 18. Thus, from time to time it is necessary to clean the laundering apparatus 14 so as to remove any built-up material from the interior surfaces of the conduits.

While a laundering apparatus such as the above-described baffle and weir arrangement may be simple to clean and maintain due to its relatively open channel construction (and when installed in an open tank), the laundering apparatus 14 shown in FIG. 1 presents some problems with regard to cleaning and maintenance. For example, in order to clean the laundering apparatus 14 of FIG. 1, the radially extending conduits 16 may be subjected to a hydroblast operation through an access port 22 located at the radially distal ends thereof. However, such a hydroblast operation fails to effectively clean the ring-shaped conduit 18 since only the interior surface areas of the ring-shaped conduit 18 immediately adjacent to and directly exposed to the radially extending conduits 16 are subjected to any cleansing effect of the hydroblast operation. Thus, a large majority of the ring-shaped conduit 18 will fail to be cleaned by such a hydroblast operation.

In order to effectively clean the ring-shaped conduit 18, a plurality of access or clean-out ports may have to be formed at various locations thereabout for manual cleaning and removal of any built-up material. Cleaning of the ring-shaped conduit 18 thus requires considerable time and effort and further extends the amount of time that the clarifier will be placed out of operation for such cleaning and maintenance.

In an effort to avoid such cleaning issues, other laundering apparatus configurations have been used with varying success. For example, referring briefly to FIG. 2, the clarifier is shown with another laundering apparatus 14′. The laundering apparatus 14′ includes a plurality of substantially linearly extending conduits 16′ which are angularly disposed relative to one another. The conduits 16′ again include a plurality of openings 20′ to draw clarified liquor therethrough and may be fluidly coupled to each other so as to convey the liquid through a designated one of the conduits 16′ to a remote location. Again, considering, for example, a hydroblast cleaning operation, the configuration of the laundering apparatus 14′ enables access for cleaning of substantially the entire interior surfaces of the conduits 16′ through associated access ports 22′. Such is contrast to the laundering apparatus 14 shown and described with respect to FIG. 1.

However, also in contrast with the laundering apparatus 14 shown and described with respect to FIG. 1, the laundering apparatus 14′ illustrated in FIG. 2 does not provide as efficient collection of the clarified liquor from within the tank 12′. This is because the radially extending conduits 16 shown in FIG. 1, along with the associated ring-shaped conduit 18, cover a more representative area of the tank and are able to collect clarified liquor from more radially disposed locations between the feedwell 19 and an outer wall of the tank 12. Such radially extending conduits 16 are further advantageous in collecting clarified liquor as any circulation or flow of the clarified liquor will essentially be in a circular motion about the tank 12. Thus, the laundering apparatus 14 illustrated in FIG. 1 has substantially uniform exposure to the body of clarified liquor within the tank 12. The laundering apparatus 14′ illustrated in FIG. 2, does not have uniform exposure to the clarified liquor in its associated tank 12′ and is limited as to the radially disposed locations between the feedwell 19′ and the outer wall of the tank 12′ from where it may collect clarified liquor.

Thus, while the laundering apparatus 14 illustrated in FIG. 1 provides efficiency in collecting clarified liquor and while the laundering apparatus 14′ illustrated in FIG. 2 provides benefits in periodic cleaning and maintenance, each apparatus 14, 14′ clearly lacks the advantages of the other.

In view of the shortcomings in the art, it would be advantageous to provide a laundering apparatus which enables efficient collection of clarified liquor from within a tank, including substantially uniform exposure to the body of clarified liquor, while also enabling simple and efficient cleaning of the entire laundering apparatus. It would further be advantageous to provide such a laundering apparatus which reduced the amount of time to clean the laundering apparatus and, thus, reduced the amount of time which an associated clarifier or other sedimentation apparatus was required to be out of operation.

### BRIEF SUMMARY OF THE INVENTION

In accordance with one aspect of the invention a laundering apparatus is provided for collecting a volume of fluid from within a tank. The laundering apparatus includes a central conduit which may be configured to at least partially circumscribe the radial center of a tank. At least one elongated conduit is tangentially coupled to, and in fluid communication with, the central conduit. At least one opening is defined in the at least one elongated conduit and configured to draw liquid through the opening into the at least one elongated conduit.

The at least one opening may include a plurality of openings which are spaced apart along a longitudinal extent of the at least one elongated conduit. Further, the at least one elongated conduit may include a plurality of such conduits coupled with the central conduit. One of the plurality of conduits may be configured as a discharge conduit for conveying collected fluid away from the interior of a tank in which the laundering apparatus may be disposed.

The at least one elongated conduit may include an access port at an end thereof which is distally located from the central conduit to provide access to the interior of the laundering apparatus for cleaning and maintenance.

The central conduit may be configured as a circuitous conduit or a non-circuitous conduit having a first and a second end. Further, the central conduit may be formed of a plurality of substantially linear conduit sections, or may include at least one arcuate conduit section.

In accordance with another aspect of the present invention, another laundering apparatus is provided. The laundering apparatus includes a circuitous conduit and a plurality of elongated, substantially radially extending conduits, each of which are tangentially coupled with the circuitous conduit. At least one opening is defined within each of the plurality of conduits which openings are configured to draw fluid therethrough and into each of the plurality of substantially radially extending conduits.

The laundering apparatus may include additional features as well. For example, the at least one opening in each of the substantially radially extending conduits may include a plurality of spaced apart openings. The circuitous conduit may include a plurality of substantially linear conduit sections angularly coupled with one another or, may include at least one arcuate conduit section. Further, the plurality of substantially radially extending conduits may each include an access port located at a radial distal end thereof to facilitate cleaning and maintenance of the laundering apparatus.

In accordance with yet another aspect of the present invention, a clarifier is provided. The clarifier includes a tank configured to hold a volume of fluid therein and a laundering apparatus disposed within the tank and configured to collect at least some of the fluid within the tank. The laundering apparatus includes a central conduit configured to at least partially circumscribe a radial center of the tank and at least one elongated conduit tangentially coupled to, and in fluid communication with, the central conduit. At least one opening is defined within the at least one elongated conduit to draw a portion of the volume of fluid therethrough and into the elongated conduit. The clarifier may include additional features, structures and components as set forth in greater detail below herein.

### BRIEF DESCRIPTION OF THE SEVERAL VIEWS OF THE DRAWINGS

The foregoing and other advantages of the invention will become apparent upon reading the following detailed description and upon reference to the drawings in which:

FIG. 1 is a plan view of a tank and associated laundering apparatus in accordance with the prior art;

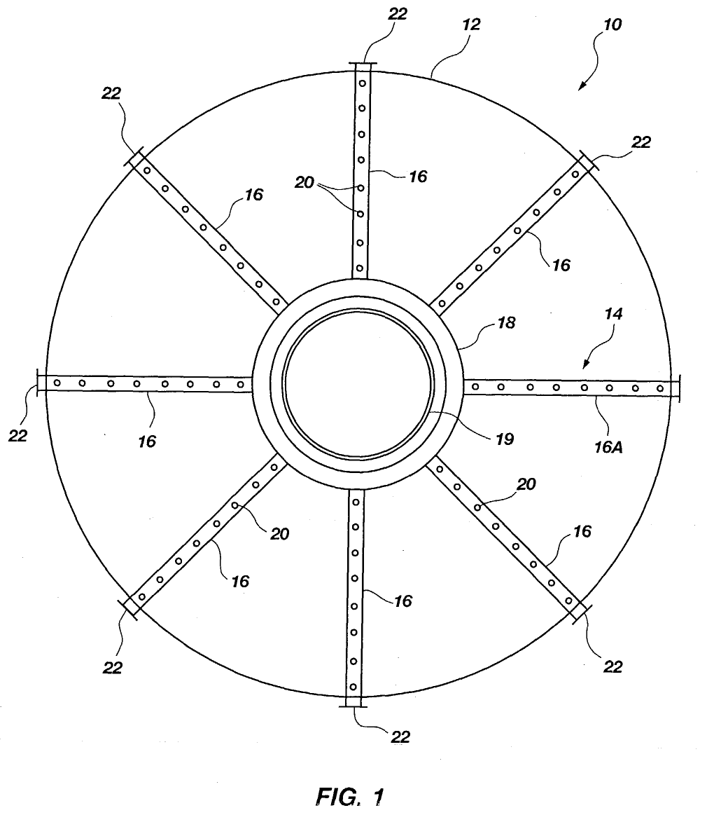

FIG. 2 is a plan view of another tank and associated laundering apparatus in accordance with the prior art;

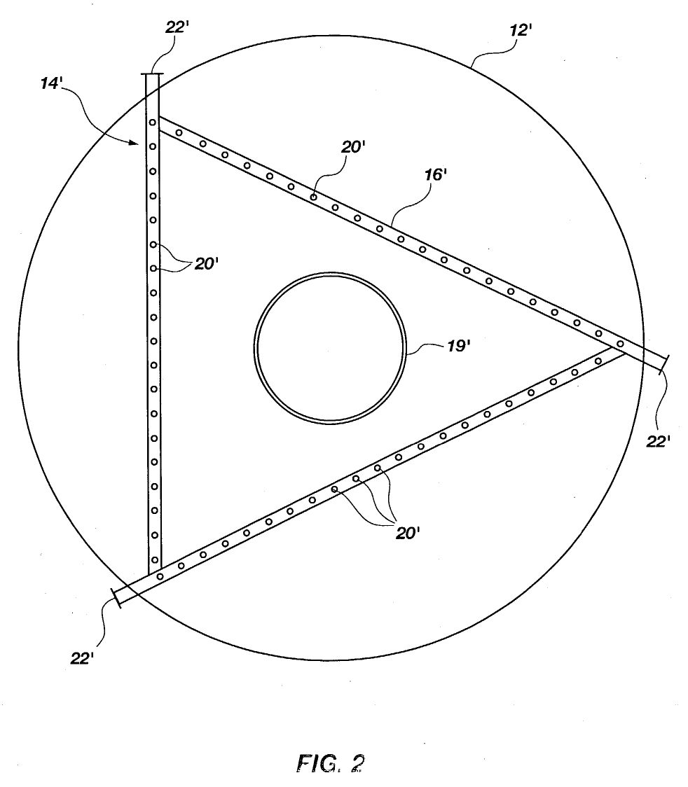

FIG. 3 is a partial cross-sectional side view of a clarifier including a laundering apparatus in accordance with an embodiment of the present invention;

FIG. 4 is a plan view of the clarifier and laundering apparatus shown in FIG. 3;

FIG. 5 is a schematic of a laundering apparatus in accordance with another embodiment of the present invention;

FIG. 6 is a schematic of a laundering apparatus in accordance with yet another embodiment of the present invention; and

FIG. 7 is a schematic of a laundering apparatus in accordance with a further embodiment of the present invention.

### DETAILED DESCRIPTION OF THE INVENTION

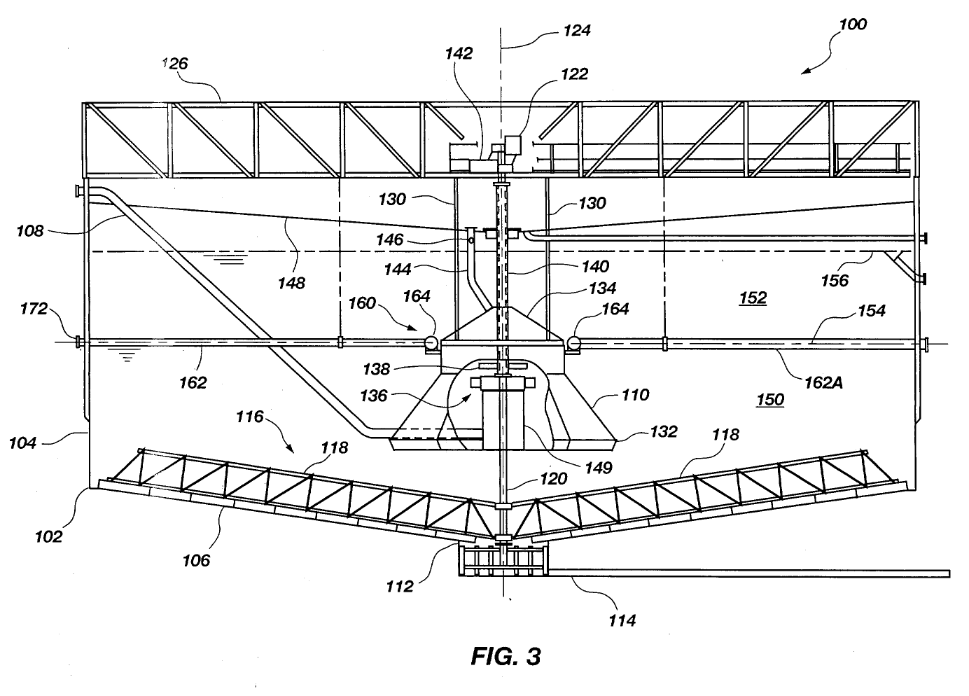

Referring to FIG. 3, a sedimentation apparatus 100, referred to herein as a clarifier, is shown in accordance with an embodiment of the present invention. The clarifier 100 is shown as a unit storage clarifier which may be used, for example, for the clarification of green liquor in a recausticizing process. It is noted, however, that the clarifier 100 may be associated with different applications and processes and that the present invention is not limited to storage-type clarifiers.

The clarifier 100 includes a tank 102 having a tank wall 104 and a tank floor or bottom 106. The tank 102 defines a volume within which a liquid containing a solids component (referred to herein as a slurry) is separated into clarified liquid and liquid/solid phases. An influent feed line 108 is positioned and configured to deliver an influent stream of the slurry into a feedwell 110. The feedwell 110 may be configured to promote mixing of the solids component of the slurry with a flocculating reagent, which may, for example, be introduced into the slurry upstream of the feedwell 110, and to also reduce the velocity of the influent slurry stream prior the slurry's entrance into the general volume defined by the tank 102.

The tank floor 106 may be flat, substantially flat, or may slope downwardly toward a central opening 112 as illustrated, to facilitate collection of the sludge, or the liquid/solids phase which has been separated from the slurry. The sludge, which in some applications may also be referred to as “dregs”, is then removed from the tank through the central opening 112 and through an underflow conduit 114. A rake assembly 116 may include one or more rake arms 118 coupled to a shaft 120 which is operatively coupled to a drive 122. The rake assembly 116 is thus configured to rotate the rake arms 118 about a defined axis 124 of the tank 102 (which in the illustrated embodiment is also the radial center of the tank) and adjacent the tank floor 106 to motivate the sludge toward the central opening 112. The rake assembly 116 may be supported, for example, from a bridge 126 which spans the tank 102. It is noted that, in some embodiments, the rake assembly 116 may not be required for the motivation of sludge toward the central opening 112 depending, for example, on the magnitude of slope the tank floor 106 exhibits.

The feedwell 110 maybe centrally located within the tank 102 (e.g., about the radial center of the tank 102 as illustrated by axis 124), and may, for example, be structurally coupled with the bridge 126 by rods, cables or other suitable structural members 130. Additional rods, cables or structural members (not shown) may be coupled between, for example, the feedwell 110 and the wall 104 of the tank 102 to further maintain the feedwell in its desired position. As illustrated, the feedwell 110 may be positioned to generally surround the rake arm shaft 120 and may include an open bottomed outer structure 132 with a substantially closed top section 134. A circulation or mixing apparatus 136 may be disposed within the feedwell 110 to facilitate the mixing of the solid particulates contained in the influent slurry with a flocculating agent so as to effect greater conglomeration of the solids content of the slurry prior to being discharged through the bottom of the feedwell 110 and into the tank 102. The mixing apparatus 136 may include rotating structures 138 such as, for example, turbines, paddles, pickets, circulation drums or other structures, which are configured to rotate about the defined axis 124 within the feedwell 110. The rotating structures 138 may be coupled to a second shaft 140 which is operatively coupled with a drive 142. The second shaft 140 may, for example, be concentrically positioned about the first shaft 124 such that the two shafts 124 and 140 are independently rotatable relative to each other.

The sides of the feedwell 110 may extend up to or above a defined maximum liquid level 156 or, as illustrated, a separate vent line 144 may be coupled to, and in fluid communication with, an upper portion of the feedwell 110. The vent line 144 may be constructed with a vent opening 146 below the roof 148 of the tank 102 so that the air can be vented into the tank 102 rather than to atmosphere so as to prevent the vent line 144 from acting as an air lift under certain conditions. It should be noted that the feedwell 110 described herein is exemplary and that other configurations of the feedwell may also be utilized.

Still referring to FIG. 3, the influent feed pipe 108 may be connected to one or more nozzles (not shown) which deliver the influent feed into the feedwell 110. The influent slurry may be redirected, such as through a feed tub or draft tube 149, and the velocity reduced to some degree within the feedwell 110 before being discharged into the tank 102. As the liquid in the tank 102 becomes more quiescent, the solids component of the slurry settles to the floor 106 of the tank 102 to form the sludge or dregs. Separation takes place in what may be termed a clarification zone 150 of the tank 102 which, for example, may be generally located in the lower one third volume of the tank 102. Clarified liquid is formed above the clarification zone 150.

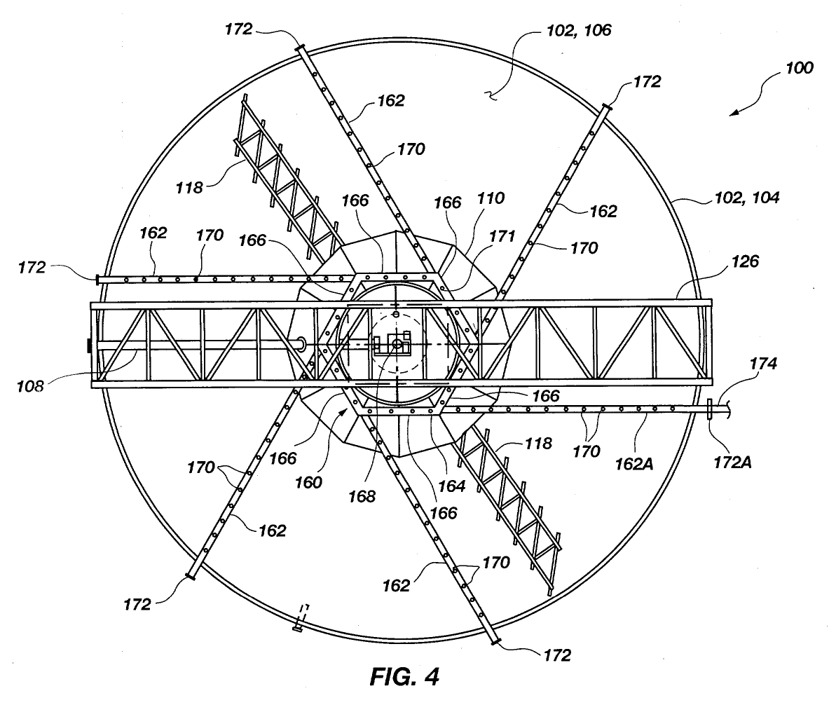

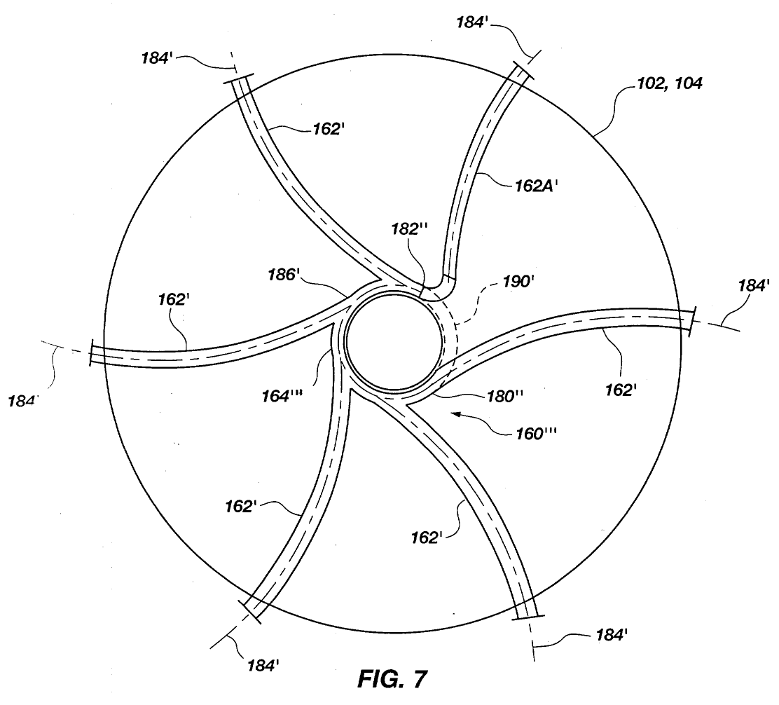

The tank 102, being configured as a unit storage clarifier tank as illustrated in FIG. 3, further includes a clarified liquid storage zone 152. Clarified liquor may be stored between a defined minimum liquid level 154 and a defined maximum liquid level 156 both of which lie above the clarification zone 150. Clarified liquid is removed from the tank 102 through a laundering apparatus 160. The laundering apparatus 160 may include one or more elongated, substantially linear and substantially radially extending conduits 162 coupled with a central conduit 164, which may also be referred to herein as the manifold. The central conduit 164 may be centrally located and configured to at least partially circumscribe the radial center of the tank 102 (e.g., such as defined by axis 124 in FIG. 3 and as generally indicated by reference numeral 168 in FIG. 4) and may also extend about the outer periphery of the feedwell 110. One or more of the substantially radially extending conduits 162A may be configured to act as the discharge conduit and convey the collected clarified liquor from the tank 102 to an external location. It is noted that the term substantially linear as used herein, allows for some minor deviation from a linear path so long as the path is generally smooth and continuous without substantial angular transitions being defined thereby. Such an embodiment is described in more detail below with respect to FIG. 7.

Referring now to FIG. 4, the central conduit or manifold 164 may comprise a plurality of substantially linear sections 166 which are in fluid communication with one another and are angularly disposed relative to adjacent sections 166. As shown in FIG. 4, the substantially linear sections 166 may be geometrically configured so as to define a polygon. Each of the substantially radially extending conduits 162 are linearly aligned with, and in fluid communication with, an associated linear section 166 of the central conduit 164 and may be substantially equally spaced around the central conduit 164 as shown in FIG. 4. While the substantially radially extending conduits 162 are not configured to be truly radial (i.e., they do not extend along a line which passes through the center 168 of the tank 102), they are substantially radially oriented within the tank 102 as they extend from a location proximate the center 168 of the tank 102 to the outer wall 104 of the tank 102 and are able to collect clarified liquid from substantially all radial distances between the manifold 164 and the outer wall 104 of the tank 102.

In operation, the laundering apparatus 160 draws clarified liquor in through a plurality of openings 170 formed in and spaced along the longitudinal extents of the substantially radially extending conduits 162. A plurality of openings 171 may also be formed in the central conduit 164 for collecting clarified liquor if so desired. The clarified liquid is conveyed from each of the substantially radially extending conduits 162, with the exception of the discharge conduit 162A, into the central conduit or manifold 164. From the manifold 164, the clarified liquor is conveyed through the substantially radially extending discharge conduit 162A to a location outside the tank 102.

The radially extending conduits 162 may extend through the tank wall 104 and have their radially distal ends configured as an access port 172. Thus, for example, the radially distal ends of the substantially radial extending conduits 162 may have a flange formed thereon with a blind flange being sealingly and removably coupled therewith. When cleaning and maintenance of the laundering apparatus 160 is required, such as to remove built-up material or scale from the interior surface of the various conduits 162 and 164, such may be accomplished through the access ports 172 of the various substantially radially extending conduits 162.

For example, a hydroblast operation may be performed through each of the substantially radially extending conduits 162 which will also effect cleaning of the associated linearly aligned sections 166 of the central conduit 164. Thus, cleaning of the interior surfaces of the entire laundering apparatus 160 may be accomplished without extraneous access ports being provided in the central conduit 164 for the independent cleaning thereof. Moreover, the entire cleaning process may be effected from the exterior of the tank 102 through the externally located access ports 172. It is noted that cleaning of the discharge conduit 162A through its associated access port 172A may require removal of a connecting pipe 174 or conduit disposed outside the tank 102.

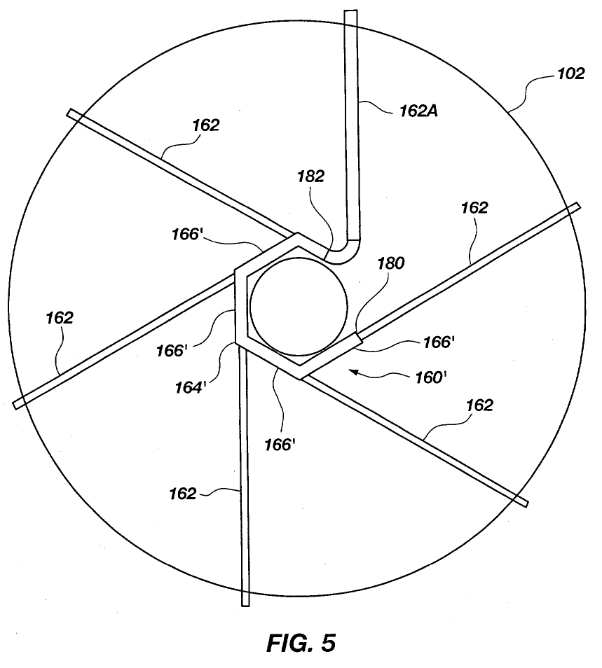

Referring briefly to FIG. 5, a schematic is shown, in plan view, of a laundering apparatus 160′ in accordance with another embodiment of the present invention. The laundering apparatus 160′ again includes a plurality of substantially radially extending conduits 162 each having a plurality of openings (not shown in FIG. 5) for drawing clarified liquor therethrough. The substantially radially extending conduits 162 are linearly aligned and coupled with and associated linear segment 166′ of a central conduit 164′ or manifold. One of the substantially radially extending conduits 162A is configured as an effluent or discharge conduit for conveying all of the collected clarified liquor to a location outside the tank 102.

The central conduit 164′ or manifold of the laundering apparatus 160′ is not configured as a circuitous conduit (e.g., a continuous ring or polygon shape) as was the case with the embodiment shown and described with respect to FIG. 4. Rather, the central conduit is configured to have a first end 180 coupled with one of the substantially radially extending conduits 162 and a second end 182 which is coupled with the discharge conduit 162A. Such a configuration is effective in collecting clarified liquor from within the tank 102 and may provide greater efficiency with respect to the flow of collected liquor as it is conveyed from the substantially radially extending conduits 162, through the central conduit 164′ and to the discharge conduit 162A. In other words, the flow path through the central conduit 164′ is more clearly defined there being only a single path to follow through the central conduit 164′ from any given substantially radially extending conduit 162.

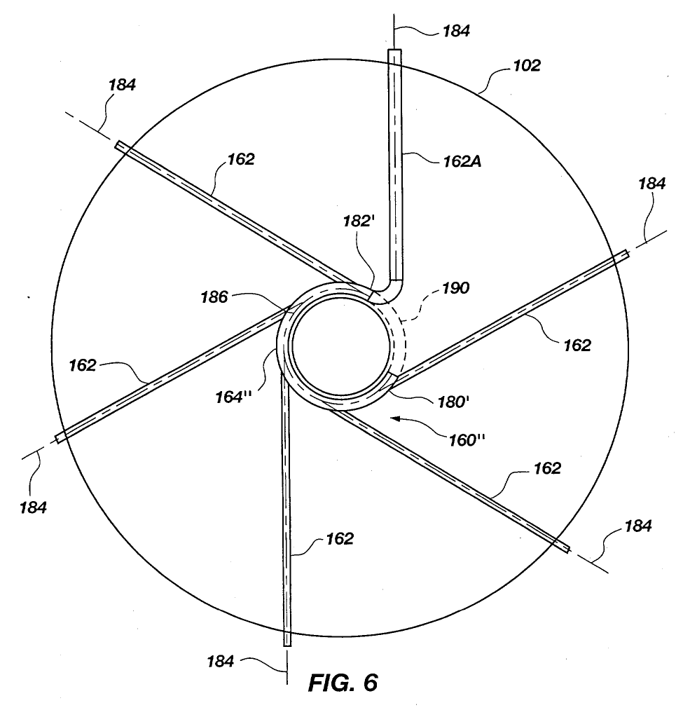

Referring briefly now to FIG. 6, a schematic is shown, in plan view, of a laundering apparatus 160″ in accordance with yet another embodiment of the present invention. The laundering apparatus 160″ includes a plurality of substantially radially extending conduits 162 each having a plurality of openings (not shown in FIG. 6) for drawing clarified liquor therethrough. The central conduit 164″, rather than being formed of a plurality of linear sections such as the embodiments described above with respect to FIGS. 4 and 5, is arcuately shaped and may be formed of one or more radiused sections of conduit. The substantially radially extending conduits 162 are coupled with the central conduit 164″ or manifold at various locations. Additionally, as is indicated by the longitudinal axes 184 of the substantially radially extending conduits 162 and the arcuate centerline 186 of the central conduit 164″, the substantially radially extending conduits 162 are tangentially disposed relative to the central conduit 164″. One of the substantially radially extending conduits 162A is configured as an effluent or discharge conduit for conveying all of the collected clarified liquor to a location outside the tank 102.

The central conduit 164″, as illustrated, includes a first end 180′ adjacent which a substantially radially extending conduit 162 is tangentially disposed relative to the central conduit 164″. The discharge conduit 162A is coupled to the second end 182′ of the central conduit 164″. Thus, as shown, the central conduit 164″ is not a circuitous member. However, as indicated by dashed lines 190, the central conduit 164″ may be formed as a circuitous member if so desired.

Referring briefly now to FIG. 7, a schematic is shown, in plan view, of a laundering apparatus 160′″ in accordance with yet another embodiment of the present invention. The laundering apparatus 160′″ includes a plurality of substantially radially extending conduits 162′ each having a plurality of openings (not shown in FIG. 7) for drawing clarified liquor therethrough. The central conduit 164′″ is arcuately shaped and may be formed of one or more radiused sections of conduit. As with other embodiments of the present invention, the central conduit may be formed of a plurality of substantially linear sections if so desired. The substantially radially extending conduits 162′ are coupled with the central conduit 164′″ or manifold at various locations. Additionally, as is indicated by the centerlines or axes 184′ of the substantially radially extending conduits 162′ and the arcuate centerline 186′ of the central conduit 164′″, the substantially radially extending conduits 162′ are tangentially disposed relative to the central conduit 164′″. One of the substantially radially extending conduits 162A′ is configured as an effluent or discharge conduit for conveying all of the collected clarified liquor to a location outside the tank 102.

The central conduit 164, as illustrated, includes a first end 180′ adjacent which a substantially radially extending conduit 162′ is tangentially disposed relative to the central conduit 164′″. The discharge conduit 162A′ is coupled to the second end 182′ of the central conduit 164′″. Thus, as shown, the central conduit 164′″ is not a circuitous member. However, as indicated by dashed lines 190′, the central conduit 164′″ may be formed as a circuitous member if so desired.

Furthermore, the substantially radially extending conduits 162′ exhibit a radius of curvature causing the substantially radial extending conduits 162′ to slightly curve away from the central conduit and out towards the wall 104 of the tank 102. Such a configuration may provide uniform exposure of the laundering apparatus 160′″ to the body of liquid contained within the tank 102 while still providing a substantially smooth and continuous flow path without sharp or abrupt directional changes within the flow path which would otherwise impede cleaning and maintenance activities associated with the laundering apparatus 160′″.

It is noted that the any of the embodiments of the laundering apparatus described herein may be characterized as having a centrally located conduit which at least partially circumscribes the radial center of the tank and one or more elongated conduits which are tangentially coupled with the central conduit and extend substantially to the outer wall of the tank. The central conduit may be circuitous or non-circuitous and may be formed, for example, to geometrically define polygon from several substantially linear sections, or may be include one or more arcuate member sections.

While the invention may be susceptible to various modifications and alternative forms, specific embodiments have been shown by way of example in the drawings and have been described in detail herein. However, it should be understood that the invention is not intended to be limited to the particular forms disclosed. Rather, the invention includes all modifications, equivalents, and alternatives falling within the spirit and scope of the invention as defined by the following appended claims.

What is claimed is:

1. A laundering apparatus configured to collect a volume of fluid from a tank, comprising:
a central conduit configured to at least partially circumscribe a radial center of the tank;
at least one substantially linear conduit substantially tangentially coupled to and in fluid communication with the central conduit, the at least one conduit having at least one opening defined therein and configured to draw a volume of fluid into the at least one substantially linear conduit.

2. The laundering apparatus of claim 1, wherein the at least one opening includes a plurality of openings spaced along a longitudinal extent of the at least one substantially linear conduit.

3. The laundering apparatus of claim 2, wherein the central conduit includes a circuitous conduit.

4. The laundering apparatus of claim 3, wherein the central conduit includes a plurality of substantially linear conduit sections wherein each substantially linear conduit section is angularly coupled with an adjacent conduit section.

5. The laundering apparatus of claim 3, wherein the central conduit includes at least one substantially arcuate section.

6. The laundering apparatus of claim 2, wherein the central conduit has a first end and a second end.

7. The laundering apparatus of claim 6, wherein the at least one substantially linear conduit includes a plurality of linear conduits and wherein a first substantially linear conduit of the plurality is coupled to the central conduit proximate the first end and wherein a second substantially linear conduit of the plurality is coupled proximate the second end.

8. The laundering apparatus of claim 7, wherein the second substantially linear conduit of the plurality is configured as a discharge conduit.

9. The laundering apparatus of claim 6, wherein the central conduit further comprises a plurality of substantially linear conduit sections wherein each conduit section is angularly coupled to an adjacent conduit section.

10. The laundering apparatus of claim 6, wherein the central conduit includes a substantially arcuate conduit section.

11. The laundering apparatus of claim 2, further comprising an access port formed at an end of the at least one substantially linear conduit and distally located from the central conduit.

12. The laundering apparatus of claim 11, wherein the at least one substantially linear conduit is sized and configured to extend beyond a wall of the tank and wherein the access port is located and configured to be accessible from a location which is external of the tank.

13. The laundering apparatus of claim 2, wherein the at least one substantially linear conduit includes a plurality of substantially linear conduits and wherein one of the plurality of substantially linear conduits is configured as a discharge conduit to convey a volume of liquid away from the central conduit.

14. The laundering apparatus of claim 1, wherein the central conduit further comprises at least one opening defined therein and configured to draw a volume of fluid into the central conduit.

15. A laundering apparatus configured to be disposed within and collect a volume of fluid from a tank, comprising:
a circuitous conduit;
a plurality of substantially radially extending conduits, each substantially radially extending conduit of the plurality being substantially tangentially coupled to, and in fluid communication with, the circuitous conduit and having at least one opening defined therein configured to draw a volume of fluid into each of the substantially radially extending conduits.

16. The laundering apparatus of claim 15, wherein the at least one opening in each of the substantially radially extending conduits includes a plurality of spaced apart openings.

17. The laundering apparatus of claim 16, wherein the plurality of substantially radially extending conduits are substantially equally spaced relative to one another about the circuitous conduit.

18. The laundering apparatus of claim 17, wherein the plurality of substantially radially extending conduits each include an access port formed in a radially distal end thereof

19. The laundering apparatus of claim 18, wherein the circuitous conduit includes at least one arcuate section.

20. The laundering apparatus of claim 18, wherein the circuitous conduit includes a plurality of substantially linear conduit sections and wherein each conduit section is angularly coupled to an adjacent conduit section.

21. The laundering apparatus of claim 14, wherein the circuitous conduit further comprises at least one opening defined therein and configured to draw a volume of fluid into the circuitous conduit.

22. A clarifier comprising:
a tank configured to hold a volume of fluid therein, said tank including a radial center; and laundering apparatus disposed within the tank, comprising:
a central conduit configured to at least partially circumscribe the radial center of the tank;
at least one substantially linear conduit substantially tangentially coupled to and in fluid communication with the central conduit, the at least one conduit having at least one opening defined therein and configured to draw a portion of the volume of fluid into the at least one substantially linear conduit.

23. The clarifier of claim 22, wherein the at least one opening includes a plurality openings spaced along a longitudinal extent of the at least one substantially linear conduit.

24. The clarifier of claim 23, further comprising a feedwell disposed within the tank proximate the radial center of the tank and wherein the central conduit at least partially circumscribes the feedwell.

25. The clarifier of claim 24, wherein the at least one substantially linear conduit includes a plurality of substantially linear conduits.

26. The clarifier of claim 25, wherein the plurality of substantially linear conduits each include an access port formed therein at a distal end relative to the central conduit.

27. The clarifier of claim 26, wherein each substantially linear conduit of the plurality extends from the central conduit beyond a side wall of the tank such that the access port formed in each substantially linear conduit is located externally of the tank.

28. The clarifier of claim 22, wherein the central conduit further comprises at least one opening defined therein and configured to draw a volume of fluid into the central conduit.
